(19) United States
(12) Patent Application Publication
(10) Pub. No.: US 2006/0109201 A1
(43) Pub. Date: May 25, 2006

(54) Wearable apparatus for converting vision signal into haptic signal, agent system using the same, and operating method thereof

(76) Inventors: Dong Wan Ryoo, Songgang-Dong (KR); Yun Kyung Park, Shinsung-Dong (KR); Jeun Woo Lee, Seongbuk-Dong (KR)

Correspondence Address: LADAS & PARRY LLP, 224 SOUTH MICHIGAN AVENUE, SUITE 1600, CHICAGO, IL, 60604, US

(21) Appl. No.: 11/210,983

(22) Filed: Aug. 24, 2005

(30) Foreign Application Priority Data
Nov. 24, 2004 (KR) 2004-97111

(51) Int. Cl. G09G 5/00

(52) U.S. Cl. 345/8

(57) ABSTRACT

A wearable apparatus for converting a vision signal into a haptic signal, an agent system using the same, and an operating method thereof are provided. If a blind person has a vision signal processing module mounted on glasses and a haptic signal processing module wore on a skin, it can be very useful for the blind person because a guide for a white cane and a voice guiding service can be provided through a network. The guide for the white cane is performed by adjusting various heights and vibration intensities of pins of a matrix according to a Y component extracted from an image of surroundings.

### BACKGROUND OF THE INVENTION

1. Field of the Invention

The present invention relates to a wearable apparatus for converting a vision signal into a haptic signal, an agent system using the same, and an operating method thereof, and more particularly, to a wearable apparatus for converting a vision signal into a haptic signal, an agent system using the same, and an operating method thereof, the wearable apparatus for perceiving an external environment through a haptic sense and vibration corresponding to a captured image signal and receiving a guiding service after transmitting an image signal through a network.

2. Description of the Related Art

A blind person can move freely in accustomed surroundings, but is restrained in movement in an unfamiliar environment. Various apparatuses have been proposed to solve the problem of restrained movement of the blind. Additionally, most public facilities have aids for the blind. A white cane is a representative aid for the blind. A guide block installed in a street or a subway can direct a white cane.

However, the movement of a blind person using a white cane is restrained until the user locates a guide block; and the white cane is more helpful if there is a guide block present in the vicinity.

The applicant of the present invention proposes an interface technology to convert a vision signal into a haptic signal that is recognizable by a non-ocular sensory organ of a blind person.

### SUMMARY OF THE INVENTION

Accordingly, the present invention is directed to a wearable apparatus for converting a vision signal into a haptic signal, an agent system using the same, and an operating method thereof which substantially obviate one or more problems due to limitations and disadvantages of the related art.

It is an object of the present invention to allow a user to perceive the external environment through an agent system having a camera and a haptic device. An image signal captured by the camera is transmitted to the haptic device. The latter, worn by the user on an appropriate location on his/her skin, is a pin-arrayed haptic device with an M×N matrix that varies heights and vibration intensities of its pins according to the size of an image signal.

It is another object of the present invention to provide an agent system using a wearable apparatus for converting a vision signal into a haptic signal, the wearable apparatus for transmitting a captured image signal and receiving additional services of the server.

It is a further another object of the present invention to provide an operating method of a wearable apparatus for converting a vision signal into a haptic signal and an agent system using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a wearable apparatus for converting a vision signal into a haptic signal, including an image capturer for capturing an image and outputting an image signal, a first microcontroller for processing a Y component of the image signal from the image capturer and outputting the processed signal, a vision signal processing module having a first transceiver for transmitting the processed Y signal and performing a communication interface with a haptic signal processing module, a second transceiver for performing a communication interface with the first transceiver, a second microcontroller for generating a control signal corresponding to the Y signal transmitted from the second transceiver, a pin-arrayed haptic device driver for generating a driving signal for varying heights and vibration intensities of pins according to the control signal, and the haptic signal processing module having a pin-arrayed haptic device for controlling the pins according to the driving signal.

In another aspect of the present invention, there is provided a agent system using a wearable apparatus for converting a vision signal into a haptic signal, including an image capturer for capturing an image and outputting an image signal, a voice input unit for inputting a voice and outputting a first voice signal, a voice output unit for outputting a second voice signal, a first microcontroller for processing a Y signal of the image signal from the image capturer and the first voice signal from the voice input unit, and delivering the second voice signal from a server to the voice output unit, a vision signal processing module having a first transceiver for performing a communication interface with a haptic signal processing module by transmitting the processed Y signal and the first voice signal, and receiving the second voice signal, a second transceiver for performing a communication interface with the first transceiver, a second microcontroller having a communication module for generating a control signal corresponding to the Y signal transmitted from the second transceiver and transmitting the first voice signal to a network, a pin-arrayed haptic device driver for generating a driving signal for varying heights and vibration intensities of pins according to the control signal, the haptic signal processing module having a pin-arrayed haptic device for controlling the pins according to the driving signal, and a server for transmitting the second voice signal or the driving signal to the haptic signal processing module through the network, the second voice signal generated by responding to the first voice signal through from the network, the driving signal generated by analyzing the Y signal through from the network.

In a further another aspect of the present invention, there is provided an operating method of a wearable apparatus for converting a vision signal into a haptic signal and an agent system, the operating method including the steps of: transmitting a Y component extracted from an image signal of an image capturer to a pin-arrayed haptic device with pins of a matrix; driving and adjusting various heights and vibration intensities of the pins; transmitting the Y component after accessing a network and call-connecting with a server that performs a guiding service when a pin-arrayed haptic device control is managed through the network; receiving a driving signal that responds to the Y component from the server; driving a pin-arrayed haptic device according to the driving signal.

According to the present invention, a user perceives the external environment through an agent system having a camera and a haptic device. The camera is mounted on the user's glasses. An image signal captured by the camera is transmitted to the haptic device through a wire/wireless communication. The haptic device, worn by the user on an appropriate location on his/her skin, is a pin-arrayed haptic device with an M×N matrix that adjusts positions (heights) and vibration intensities of its pins according to the size of an image signal.

For example, the position of the pin is high when a level of a luminance (Y) signal is high. The position of the pin is low and vibration intensity is strong when a level of a Y signal is low. Consequently, the user perceives the external environment by positions and vibration intensities of pins.

Additionally, the user, who is not familiar with the device or want additional road information, transmits an image through the network and receives additional services from a server, an automatic answering machine, or an operator by using the wearable apparatus for converting a vision signal into a haptic signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a control block diagram of an agent system;

FIG. 2 illustrates a control block diagram of a pin-arrayed haptic device;

FIG. 3 illustrates a schematic view of a wearable apparatus for converting a vision signal into a haptic signal according to an embodiment of the present invention; and

FIG. 4 illustrates a control process flowchart of an agent system.

### DETAILED DESCRIPTION OF THE INVENTION

Reference will now be made in detail to the preferred embodiments of the present invention, examples of which are illustrated in the accompanying drawings.

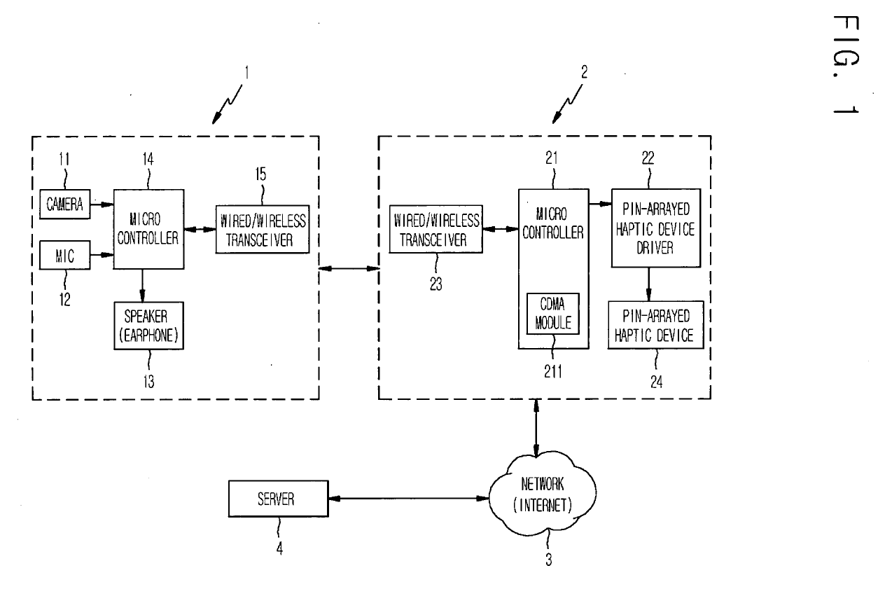

FIG. 1 illustrates a control block diagram of an agent system. Referring to FIG. 1, a wearable apparatus for converting a vision signal into a haptic signal includes two modules, one module installed on glasses and the other module wore on a body according to the present invention.

The module installed on glasses is a vision signal processing module 1 including a camera 11, a microphone 12, a speaker (earphone) 13, a microcontroller (MCU) 14, and a wire/wireless transceiver 15. Here, the microphone 12 and the speaker (earphone) 13 can be removed from the vision signal processing module 1 when a voice service of the agent system is unnecessary.

The camera 11 is a device for inputting an image and disposed on the inner surface of glasses. The microphone 12 is a device for inputting a voice and disposed on the inner surface of the glasses. The speaker (earphone) 13 for delivering a voice signal to a user is disposed on a portion of the glasses near the ears. The microcontroller 14 for delivering and processing an image (Y) and a voice signal is disposed on an appropriate portion of glasses. The wire/wireless transceiver 15 transmits an extracted Y-signal of an image into a pin-arrayed haptic device 24.

The module wore on a body is a haptic signal processing module 2 including a microcontroller 21, a pin-arrayed haptic device driver 22, a wire/wireless transceiver 23, and a pin-arrayed haptic device 24.

The microcontroller 21 includes a function of a mobile phone (internet), connects an external network, and processes various signals. A function of the mobile phone specifically means CDMA module 211. The pin-arrayed haptic device driver 22 adjusts various heights and vibration intensities of pins respectively in the pin-arrayed haptic device 24. A wire/wireless transceiver 15 transmits an extracted Y-signal of an image and a voice signal to the haptic signal processing module 2. The pin-arrayed haptic device 24 has a M×N matrix, is wore on an appropriate position of a skin, and delivers a grey image to a user in terms of a haptic signal with various positions (heights) and vibration intensities of pins.

Accordingly, the present invention is directed to an agent system using a wearable apparatus for converting a vision signal into a haptic signal. A network 3 for a mobile communication and a server 4 for a guiding service are included to provide additional services to an agent system using a wearable apparatus for converting a vision signal into a haptic signal of the present invention. The agent system can use an automatic answering server other than the server 4. Additionally, a guiding service operator can deliver a guiding voice to a wearable apparatus for converting a vision signal into a haptic signal by monitoring an image data transmitted from a user in real time.

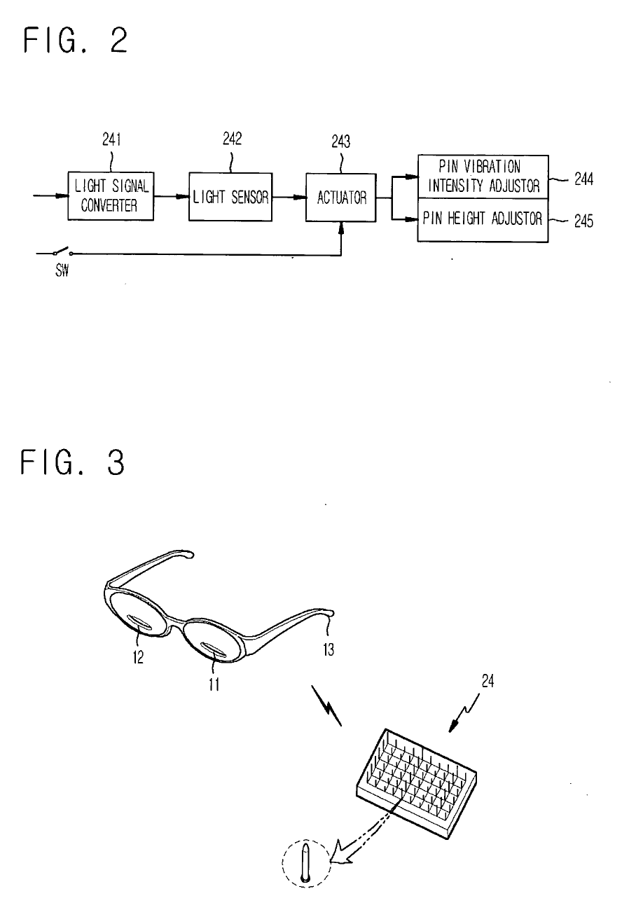

FIG. 2 illustrates a control block diagram of a pin-arrayed haptic device. Referring to FIG. 2, the pin-arrayed haptic device 24 includes an optical signal converter 241, an optical sensor 242, an actuator 243, a pin vibration intensity adjustor 244, and a pin height adjustor 245.

The optical signal converter 241 converts a luminance signal into an optical signal. The optical sensor 242 converts the optical signal into an electric signal according to an intensity of the optical signal. The actuator 243 drives various heights or vibration intensities of pins. The pin vibration intensity adjustor 244 adjusts the vibration intensity of the pin representative of a pixel according to luminance using an inputted luminance signal. The vibration intensity strengthens as the luminance becomes lower in an embodiment of the present invention. The pin vibration intensity adjustor 244 adjusts the height of the pin representative of a pixel according to luminance using the inputted luminance signal. The height of the pin is lowered as the luminance becomes lower in an embodiment of the present invention.

FIG. 3 illustrates a schematic view of a wearable apparatus for converting a vision signal into a haptic signal according to an embodiment of the present invention. More specifically, FIG. 3 is a schematic perspective view of a pin-arrayed haptic device 24 with an M×N matrix and a view of a wearable apparatus for converting a vision signal into a haptic signal.

Referring to FIG. 3, a camera 11 and a microphone 12 are attached to glasses and receive an image input and a voice input respectively. Additionally, a speaker (earphone) 13 is attached to a portion of glasses near the ears and outputs a voice. Moreover, a wearable pin-arrayed haptic device 24 with a M×N matrix contacts a user's skin and delivers a grey image to the user in terms of a haptic signal with varying positions (heights) and vibration intensities of pins.

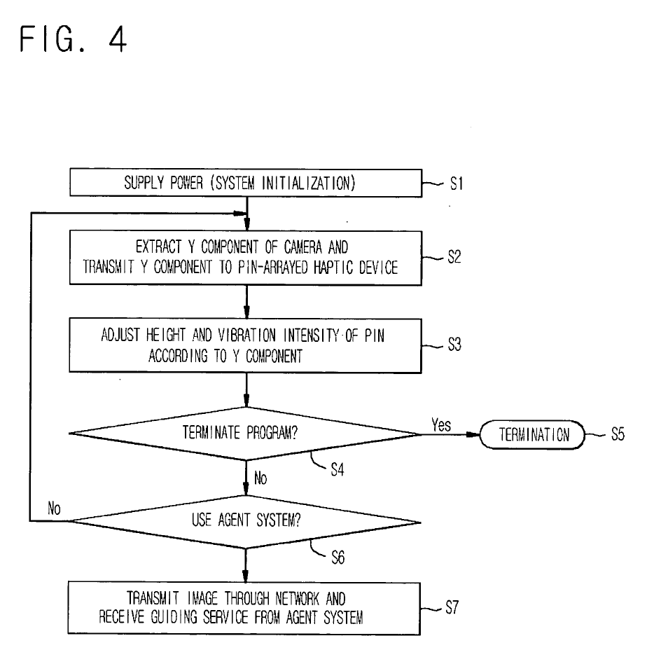

Then, a control process of a wearable apparatus for converting a vision signal into a haptic signal with the above structure and an operating method of an agent system using the wearable apparatus will now be described with reference to FIG. 4.

FIG. 4 illustrates a control process flowchart of an agent system.

A start input is inputted by a user (S1).

An extracted Y component of a camera 11 is delivered to a pin-arrayed haptic device 24 (S2).

Various heights and vibration intensities of pins in the pin-arrayed haptic device 24 are adjusted according to the Y component (S3).

After checking a termination input from a user (S4), if there is the termination input, terminates a program (S5), if not, updates the positions and the vibration intensities of the pins in the pin-arrayed haptic device 24 with a continuously extracted grey image (Y) component.

After checking a start input for a agent system (S6), if there is the start input, connect to a network 3, if not, keep updating positions and vibration intensities of the pins in the pin-arrayed haptic device 24 with a continuously extracted grey image (Y) component.

When there is a requesting signal for the agent system, sending an image signal after connecting with the network 3, and receiving a guiding service from a server 4 of the agent system (S7).

The guiding service provides road information to the blind by using location information, an acquired image signal, and a built-in road database. Methods of using an agent system are: delivering the Y component of an image and receiving the corresponding driving signal, receiving a voice guiding service based on the image signal, and requesting a guiding service with a user's voice and receiving a voice guiding service. Here, a voice guiding service is provided by an automatic answering system or a guiding service operator.

A program is terminated by a user's input (S5).

As described above, a wearable apparatus for converting a vision signal into a haptic signal, an agent system using the same, and an operating method thereof can be used especially for the blind by perceiving a haptic sense and vibration from a wearable apparatus. More particularly, the guiding service can be provided to a user because an captured image signal of a camera is transmitted through a network after the network of an agent system is connected with the wearable apparatus by a user's need.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A wearable apparatus for converting a vision signal into a haptic signal, comprising:
an image capturer for capturing an image and outputting an image signal;
a first microcontroller for processing a Y component of the image signal from the image capturer and outputting the processed signal;
a vision signal processing module having a first transceiver for transmitting the processed Y signal and performing a communication interface with a haptic signal processing module;
a second transceiver for performing a communication interface with the first transceiver;
a second microcontroller for generating a control signal corresponding to the Y signal transmitted from the second transceiver;
a pin-arrayed haptic device driver for generating a driving signal for varying heights and vibration intensities of pins according to the control signal; and
the haptic signal processing module having a pin-arrayed haptic device for controlling the pins according to the driving signal.

2. The wearable apparatus of claim 1, wherein the pins of the pin-arrayed haptic device are an M×N matrix, where M and N are natural numbers.

3. The wearable apparatus of claim 1, where the pin-arrayed haptic device includes:
an optical signal converter for converting a luminance (Y) signal into an optical signal;
an optical sensor for generating an electric signal corresponding to an inputted optical intensity;
an actuator for raising or lowering, and vibrating the pins;
a pin vibration intensity adjustor for adjusting vibration intensities of the pins representative of each pixel according to the luminance signal; and
a pin height adjustor for adjusting various heights of the pins representative of each pixel according to the luminance signal.

4. The wearable apparatus of claim 1, where the vision signal processing module is mounted on glasses, and the haptic signal processing module is wore on a user's body.

5. An agent system using a wearable apparatus for converting a vision signal into a haptic signal, comprising:
an image capturer for capturing an image and outputting an image signal;
a voice input unit for inputting a voice and outputting a first voice signal;
a voice output unit for outputting a second voice signal;
a first microcontroller for processing a Y signal of the image signal from the image capturer and the first voice signal from the voice input unit, and delivering the second voice signal from the agent system to the voice output unit;
a vision signal processing module having a first transceiver for performing a communication interface with a haptic signal processing module by transmitting the processed Y signal and the first voice signal, and receiving the second voice signal;
a second transceiver for performing a communication interface with the first transceiver;
a second microcontroller having a communication module for generating a control signal corresponding to the Y signal transmitted from the second transceiver and transmitting the first voice signal to a network;
a pin-arrayed haptic device driver for generating a driving signal for varying heights and vibration intensities of pins according to the control signal;
the haptic signal processing module having a pin-arrayed haptic device for controlling the pins according to the driving signal; and
a server for transmitting the second voice signal or the driving signal of the pin-arrayed haptic device to the haptic signal processing module through the network, the second voice signal generated by responding to the first voice signal through from the network, the driving signal generated by analyzing the Y signal through from the network.

6. The agent system of claim 5, where the pins of the pin-arrayed haptic device are an M×N matrix, where M and N are natural numbers.

7. The agent system of claim 5, where the pin-arrayed haptic device includes:
an optical signal converter for converting the luminance (Y) signal into an optical signal;
an optical sensor for generating an electric signal corresponding to an inputted optical intensity;
an actuator for raising or lowering, and vibrating the pins;
a pin vibration intensity adjustor for adjusting vibration intensities of the pins representative of each pixel according to the luminance signal; and
a pin height adjustor for adjusting various heights of the pins representative of each pixel according to the luminance signal.

8. The agent system of claim 5, where the communication module is a CDMA module.

9. The agent system of claim 5, where the agent system includes an automatic answering service system for generating a voice according to an analysis of the Y signal.

10. An operating method of a wearable apparatus for converting a vision signal into a haptic signal and an agent system, comprising the steps of:
(a) transmitting a Y component extracted from an image signal of an image capturer to a pin-arrayed haptic device with pins of a matrix;
(b) driving and adjusting various heights and vibration intensities of the pins;
(c) transmitting the Y component after accessing a network and call-connecting with a server that performs a guiding service when a pin-arrayed haptic device control is managed through the network;
(d) receiving a driving signal that responds to the Y component from the server; and
(e) driving a pin-arrayed haptic device according to the driving signal.

11. The method of claim 10, wherein vibration intensities and various heights of the pins representative of each pixel are adjusted according to a luminance signal of the Y component in the step (b).

12. The method of claim 10, wherein a voice signal service is provided by transmitting a voice signal in the step (c).
